(19) United States
(12) Patent Application Publication
(10) Pub. No.: US 2008/0037669 A1
(43) Pub. Date: Feb. 14, 2008

(54) WIRELESS COMMUNICATION METHOD AND SYSTEM FOR INDEXING CODEBOOK AND CODEWORD FEEDBACK

(75) Inventors: Kyle Jung-Lin Pan, Smithtown, NY (US); Fatih M. Ozluturk, Port Washington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/834,155

(22) Filed: Aug. 6, 2007

Related U.S. Application Data
(60) Provisional application No. 60/837,025, filed on Aug. 11, 2006.

(51) Int. Cl. H04L 1/02; H04K 1/10; H04L 27/04; H04L 27/28

(52) U.S. Cl. 375/260; 375/262; 375/267; 379/299

(57) ABSTRACT

The present invention is related to indexing channel information feedback in a multiple-input multiple-output (MIMO)-based wireless communication system. In one embodiment, at least one measurement of a channel metric is performed. The measured channel metric is quantized and a codeword is selected that represents the measured channel metric. Feedback is generated based on the channel metric measurement. The feedback includes an index to the selected codeword. A codebook is generated by partitioning a plurality of codewords into two or more tiers, assigning indices to the codewords and correlating the codewords in complex vector space and Hamming distance in binary indices. For any given codeword, a first subset of the codewords may have a higher correlation with respect to the given codeword. In another embodiment, the number of bits used to report codebook indexing is determined based on the frequency of the generation of the feedback.

### CROSS REFERENCE TO RELATED APPLICATION

This application claims the benefit of U.S. Provisional Application No. 60/837,025 filed Aug. 11, 2006, which is incorporated by reference as if fully set forth.

### FIELD OF INVENTION

The present invention is related to a wireless communication system. More particularly, the present invention is related to a wireless communication method and system for indexing codebook and codeword feedback for multiple-input multiple-output (MIMO) precoding for evolved universal terrestrial radio access (E-UTRA).

### BACKGROUND

In order to keep the technology competitive, both the third generation partnership project (3GPP) and 3GPP2 are considering long term evolution (LTE), in which evolution of radio interface and network architecture are necessary.

In accordance with a 3GPP technical report (TR) 25.814, use of precoding as a means to convert the antenna domain MIMO signal processing into the beam domain processing should be investigated, and both codebook-based precoding and non-codebook based precoding should be considered. The codebook-based method selects at least one precoding vector or matrix from at least one codebook to reduce the signaling overhead. The size of the codebooks should be minimized and the codebooks should be static. Irrespective of whether or not the codebook is used, the amount of feedback should be minimized.

An indexing scheme for a codebook is essential for codebook-based MIMO systems. FIG. 1A shows a conventional codebook with sixteen codewords indexed by decimal numbers from 1-16. FIG. 1B shows a conventional codebook with a corresponding binary indexing.

An efficient indexing scheme is desired that can improve MIMO systems, enable fast identification and searching of the codewords, and facilitate efficient and systematic construction and reconstruction of the codebooks with reduced signaling overhead. Therefore, it is desirable to provide a method and system that provides efficient indexing for codebook-based MIMO systems.

### SUMMARY

The present invention is related to indexing channel information feedback in a MIMO-based wireless communication system. In one embodiment, at least one measurement of a channel metric is performed. The measured channel metric is quantized and a codeword is selected that represents the measured channel metric. Feedback is generated based on the channel metric measurement. The feedback includes an index to the selected codeword. A codebook is generated by partitioning a plurality of codewords into two or more tiers, assigning indices to the codewords and correlating the codewords in complex vector space and Hamming distance in binary indices. For any given codeword, a first subset of the codewords may have a higher correlation with respect to the given codeword. In another embodiment, the number of bits used to report codebook indexing is determined based on the frequency of the generation of the feedback.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1A shows a conventional codebook with sixteen codewords indexed from 1-16;

FIG. 1B shows a conventional codebook with a corresponding binary indexing;

FIG. 2 is a block diagram of a MIMO-based wireless communication system configured in accordance with the present invention;

FIGS. 3A and 3B show an exemplary codebook indexing method implemented by the system of FIG. 2 in accordance with a first embodiment of the present invention;

FIG. 4 shows the resulting indexing of the method of FIGS. 3A and 3B;

FIGS. 5 and 6 show codeword partitioning and codebook indexing implemented by the system of FIG. 2 in accordance with the second embodiment of the present invention; and

FIG. 7 shows codebook indexing reporting method implemented by the system of FIG. 2 in accordance with the present invention.

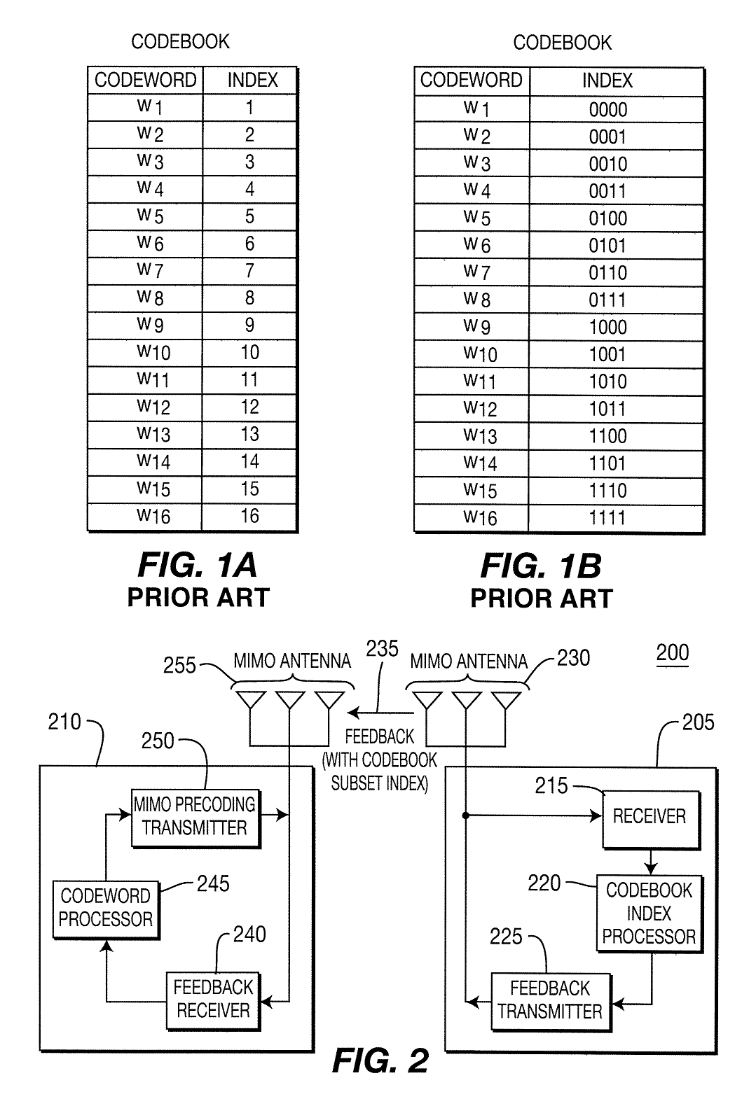

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to an eNodeB, a site controller, an access point (AP), or any other type of interfacing device capable of operating in a wireless environment.

The present invention provides efficient indexing methods for codebook-based MIMO systems. The indexing methods of the present invention may be applied to both downlink and uplink MIMO for precoding and/or beamforming. The indexing methods of the present invention achieve a more efficient MIMO precoding operation, and enable fast searching and identifying of the desired codewords, efficient construction and reconstruction of the codebooks and reduced unnecessary signaling.

Hereinafter, the present invention will be explained with reference to sixteen (16) codewords in a codebook, and partitioning of the codewords into two or three tiers. However, it should be noted that the present invention is applicable to any number of codewords and any number of tiers.

FIG. 2 is a block diagram of a MIMO-based wireless communication system 200 configured in accordance with the present invention. The system 200 includes a first wireless communication unit 205 and a second wireless communication unit 210. The units 205 and 210 may be a WTRU, a base station or any other wireless communication device.

The first wireless communication unit 205 includes a receiver 215, a codebook index processor 220 and a feedback transmitter 225 and a MIMO antenna 230. The receiver 215 in the first wireless communication unit 205 performs at least one measurement of channel metrics, (e.g., channel impulse responses, channel variation rate, Doppler shift, vehicle speed and the like), received via the MIMO antenna 230. The results of the measurement of channel metrics performed by the first wireless communication unit 205 may be signaled to the second wireless communication unit 210, or the results of the measurement of channel metrics performed by the second wireless communication unit 210 may be signaled to the first wireless communication unit 205, or both of the first and second wireless communication units 205 and 210 may be synchronized to each perform the measurement of channel metrics.

The codebook index processor 220 in the first wireless communication unit 205 uses the results of the measurement to select a subset of a predetermined global codebook. The predetermined global codebook may be stored in a memory located within the codebook index processor 220, elsewhere in the first wireless communication unit 205, or external to the first wireless communication unit 205, as long as it is accessible by the codebook index processor 220.

For example, in a two-tier global codebook, if a vehicle speed measurement determines that the speed is low, a first tier codebook subset is selected. Otherwise, a second tier codebook subset is selected. If a three-tier global codebook is used, the speed can be partitioned into ranges of low, medium and high speed, and a corresponding first, second and third tier codebook subset is selected by the codebook index processor 220.

After the codebook subset is selected, the codebook index processor 220 uses the measurement results to select the best codeword in the selected codebook subset based on certain criterion such as signal-to-interference-plus-noise ratio (SINR), mean square error (MSE), channel capacity, and the like. This may be performed by searching through the codewords in the selected codebook subset and finding the codeword that has the highest SINR, lowest MSE or largest channel capacity. Once the best codeword in the selected codebook subset is found, the codebook index processor 220 assigns a codebook subset index to the best codeword and forwards the codebook subset index to the feedback transmitter 225 in the first wireless communication unit 205, which sends feedback 235 including the codebook subset index to the second wireless communication unit 210 via the MIMO antenna 230.

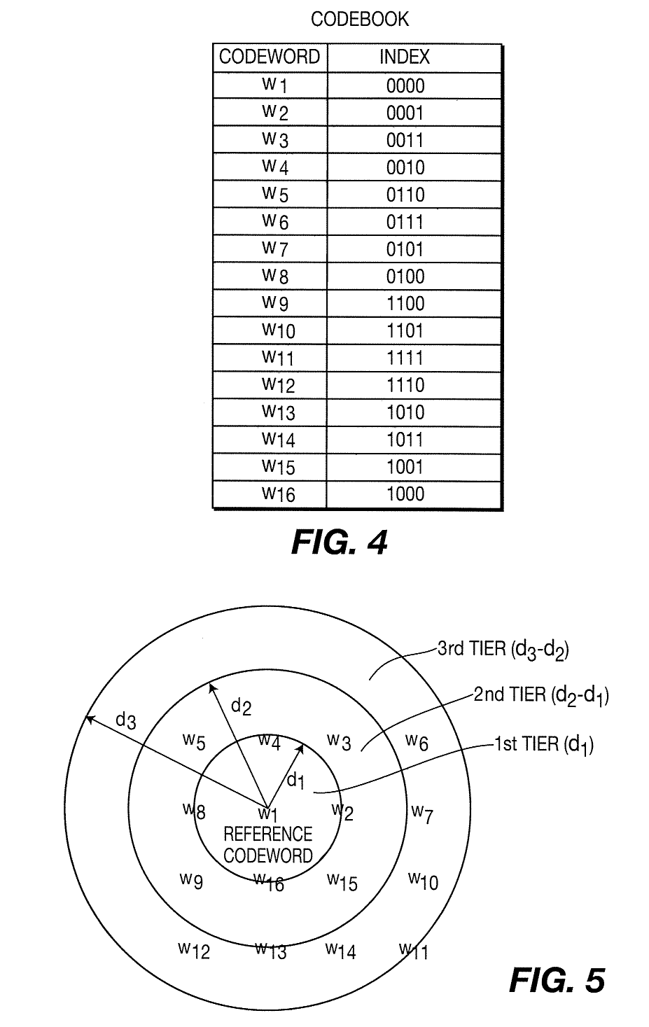

Still referring to FIG. 2, the second wireless communication unit 210 includes a feedback receiver 240, a codeword processor 245, a MIMO preceding transmitter 250 and a MIMO antenna 255. The feedback receiver 240 in the second wireless communication unit 210 receives the feedback 235 from the first wireless communication unit 205 via the MIMO antenna 255, and forwards the feedback 235 to the codeword processor 245 in the second wireless communication unit 210. The codeword processor 245 performs codebook subset selection based on the results of measurement of channel metrics, codebook subset to global codebook index translation and global codebook index to codeword mapping. Once the codebook processor 245 selects a codebook subset, it translates the codebook subset index included in the received feedback 235 to a global codebook index and performs global codebook index-to-codeword mapping using a codebook look-up table (LUT), such as the one shown in FIG. 4. The codebook LUT may be stored in a memory located within the codeword processor 245, elsewhere in the second wireless communication unit 210, or external to the second wireless communication unit 210, as long as it is accessible by the codeword processor 245.

For example, if a first tier is selected as the current codebook subset, and suppose the previous codeword is w₁ (global codebook index 0000). The feedback receiver 240 processes the codebook subset index in the received feedback 235 and decodes the bits in the feedback 235 to be either “00”, “01”, “10” or “11”, the codeword processor 245 first translates “00”, “01”, “10” or “11” into “0001”, “0010”, “0100” or “1000” respectively using the following Table 1.

TABLE 1
Example codebook subset index to global codebook index translation table
for codeword w₁

| Codebook Subset Index | Global Codebook Index |
|---|---|
| 00 | 0001 |
| 01 | 0010 |
| 10 | 0100 |
| 11 | 1000 |

Table 1 is constructed using a codebook construction set (that is discussed in a later section). The codeword processor 245 then maps the global codebook index 0010 to a codeword w₄ using the codebook LUT shown in FIG. 4. If the previous codeword is w₂. (global codebook index “0001”) and if the feedback receiver 240 decodes the feedback 235 to be “11”. The codeword processor 245 then translates “11” into “1001” using the following Table 2.

TABLE 2
Example codebook subset index to global codebook index translation
table for codeword w₂

| Codebook Subset Index | Global Codebook Index |
|---|---|
| 00 | 0000 |
| 01 | 0011 |
| 10 | 0101 |
| 11 | 1001 |

The codeword processor 245 then maps the global codebook index “1001” to a codeword w₁₅ using codebook LUT in FIG. 4. In general, there is a codebook subset mapping table, (as shown in Tables 1 and 2), for each codeword in each codebook subset. Such tables can be generated in real time using codebook construction set as discussed in a later section. Using different codebook construction sets for constructing codebook subsets results in a different size of a codebook subset, (i.e., a different number of bits used to represent the codewords in the constructed codebook subset), and thus results in different codebook subset mapping tables, (mapping to global codebook index). Alternatively, the tables can be generated beforehand and stored in a memory located within the codeword processor 245, elsewhere in the second wireless communication unit 210, or external to the second wireless communication unit 210, as long as it is accessible by the codeword processor 245.

In generating the feedback 235, the first wireless communication unit 205 performs a channel estimation, (to generate channel impulse responses) and selects the codebook subset based on certain channel metrics. The first wireless communication unit 205 then computes the codeword selection metric, such as SINR, MSE or the like, for each codeword in the codebook subset and selects a codeword which has the best codeword selection metric, such as the highest SINR or the smallest MSE.

Alternatively, the first wireless communication unit 205 performs a channel estimation, decomposes the estimated channel using, for example, a singular value decomposition (SVD) to find the floating-point eigen-vectors, (or the precoding matrix), and quantizes the floating-point eigen-vectors or preceding matrix into a codeword within a codebook subset that is selected. The first wireless communication unit 205 then sends an index to the selected codeword to the second wireless communication unit 210 as the feedback 235. The channel metrics measured by the first wireless communication unit 205, (or the second wireless communication unit 210 as well), includes, but is not limited to, channel correlation, channel variation rate, vehicle speed, Doppler shift, phase changes or any other appropriate metric.

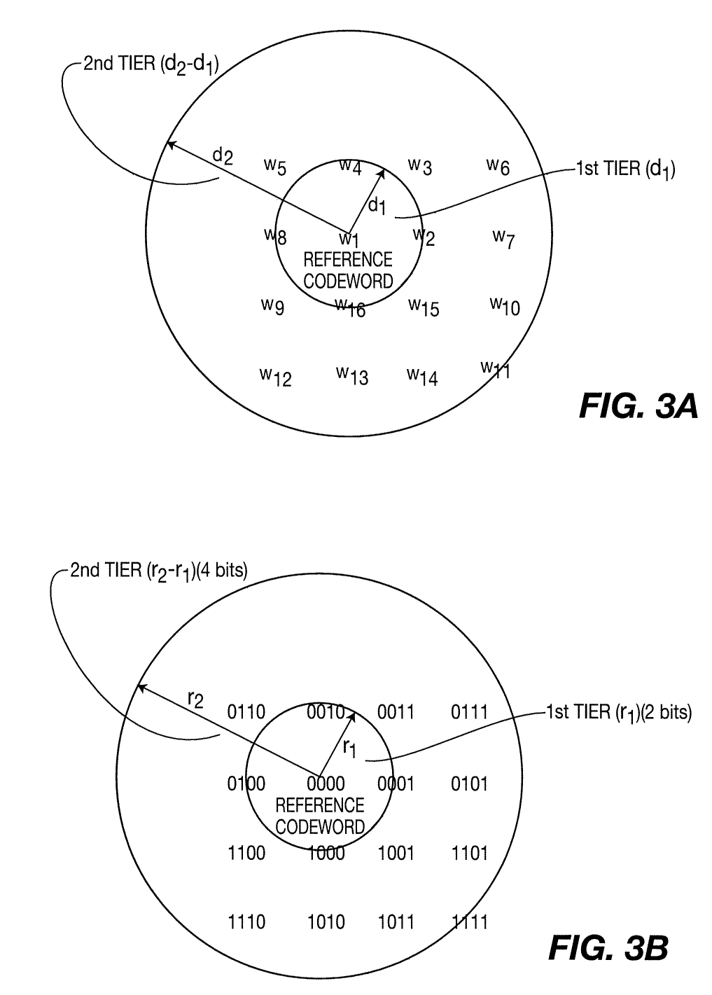

FIGS. 3A and 3B show an exemplary codebook indexing method implemented by the system 200 of FIG. 2 in accordance with a first embodiment of the present invention. FIG. 4 shows the resulting indexing of the method of FIGS. 3A and 3B. As shown in FIG. 3A, a plurality of codewords (w₁-w₁₆) are partitioned into two tiers, (i.e., subsets). As shown in FIG. 3B, indices are assigned to the codewords based on some appropriate criteria such as Hamming distance that relates the codewords with the indices. The object of partitioning the codewords is to develop efficient indexing system that can be adapted to the channel conditions for efficient MIMO operations.

The indexing may be determined based on the relationship between the correlation of codewords in complex vector space and Hamming distance in binary indices. The arrangement of codewords is fixed once it is determined. In the example illustrated by FIGS. 3A and 3B, the sixteen codewords are arranged in such a way that, for any given codeword, neighboring codewords have a higher correlation, (or larger inner product), while remote codewords have a lower correlation, (or smaller inner product), with respect to the given codeword. For the example of sixteen codewords w₁-w₁₆ shown in FIGS. 3A and 3B, for a given codeword w₁, codewords w₂, w₄, w₈ and w₁₆ have a larger correlation with respect to the codeword w₁, while codewords w₃, w₅, w₆, w₇, w₉, w₁₀, w₁₁, w₁₂, w₁₃, w₁₄ and w₁₅ have a lower correlation with respect to the codeword w₁.

The sixteen indices are arranged in such a way that, for any given index, the neighboring indices have a smaller Hamming distance while the remote indices have a larger Hamming distance with respect to the given codeword. For example, for a given index 0000, the indices 0001, 0010, 0100 and 1000 have a Hamming distance of one with respect to the index 0000, while indices 0011, 0110, 0111, 0101, 1100, 1101, 1111, 1110, 1010, 1011 and 1001 have a Hamming distance of two or greater with respect to the index 0000. The variables d₁ and d₂ represent the “distance” in the codeword space. For example, correlation can be used as a measure of “distance”. For example, if codeword w₁ is used as a reference point, the first tier codewords are within “distance” of d₁ and the second tier codewords are within “distance” of d₂. The variables r₁ and r₂ represent the Hamming distance in indexing space. For example, if 0000 is used as a reference point, the first tier indices are within “distance” of r₁ and the second tier indices are within “distance” of r₂.

The codewords and the indices are mapped to each other. First, any one of the sixteen indices is arbitrarily assigned to the codeword w₁. Then, the first tier indices are assigned to the first tier codewords and the second tier indices are assigned to the second tier codewords. For example, the index 0000 is assigned to the codeword w₁. Then, the indices 0001, 0010, 0100 and 1000 are assigned to the codewords w₂, w₄, w₈ and w₁₆, respectively. The indices 0011, 0110, 0111, 0101, 1100, 1101, 1111, 1110, 1010, 1011 and 1001 are assigned to the codewords w₃, w₅, w₆, w₇, w₉, w₁₀, w₁₁, w₁₂, w₁₃, w₁₄ and w₁₅, respectively. FIG. 4 shows the resulting indexing of the method of FIGS. 3A and 3B.

The correlation (or inner product) of two codewords u and w is as follows: if u and w are vectors:

correlation=∥u^{H}w∥. Equation (1)

If u and w are matrices:

correlation=\sqrt{trace(w^{H}uu^{H}w)} Equation (2)

The Hamming distance of two codewords u and w is obtained as follows:

r=weight(u+w); Equation (3)

where the + means an exclusive OR (XOR) operation and the “weight” is a function of counting the number of ones in the resulting vector u+w.

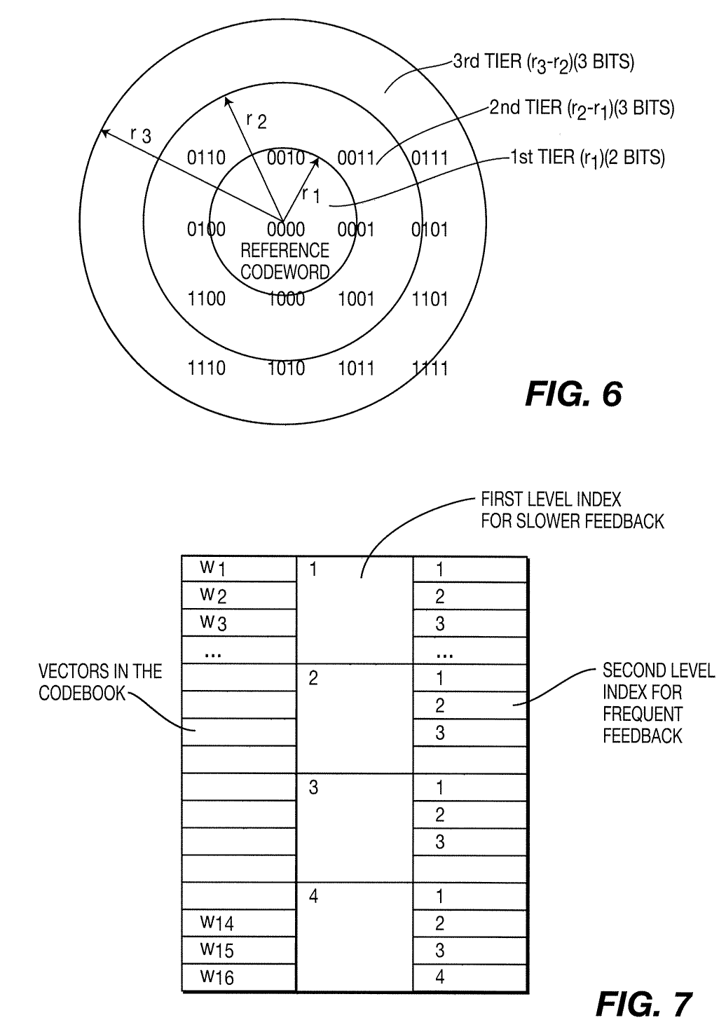

FIGS. 5 and 6 show codeword partitioning and codebook indexing implemented by the system 200 of FIG. 2 in accordance with the second embodiment of the present invention, whereby sixteen codewords w₁-w₁₆ are partitioned into three tiers. The sixteen codewords are arranged in such a way that for any given codeword, the first tier codewords have the highest correlation, (i.e., largest inner product), the second tier codewords have the medium correlation, (i.e., medium inner product), and the third tier codewords have the lowest correlation, (i.e., smallest inner product), with respect to the given codeword. For example, for a given codeword w₁, codewords w₂, w₄, w₈ and w₁₆ have the largest correlation, (i.e., largest inner product), with respect to the codeword w₁ and are included in the first tier, codewords w₃, w₅, w₇, w₉, w₁₃ and w₁₅ have the medium correlation, (i.e., medium inner product), with respect to the codeword w₁ and are included in the second tier, and codewords w₆, w₁₀, w₁₁, w₁₂ and w₁₄ have the lowest correlation, (i.e., smallest inner product), with respect to the codeword w₁ and are included in the third tier.

The sixteen indices are arranged in such a way that, for any given index, indices assigned to the first tier codewords have the smallest Hamming distance, indices assigned to the second tier codewords have the medium Hamming distance, and the indices assigned to the third tier codewords have the largest Hamming distance with respect to the given codeword. For example, for a given index 0000, the indices 0001, 0010, 0100 and 1000 have a Hamming distance of one (r₁=1)with respect to the index 0000 and are in the first tier, the indices 0011, 0110, 0101, 1100, 1010 and 1001 have a Hamming distance of two (r₂=2) with respect to the index 0000 and are in the second tier, and the indices 0111, 1101, 1111, 1110 and 1011 have a Hamming distance of three (r₃=3) or greater with respect to the index 0000 and are in the third tier.

The codewords and the indices are mapped to each other. Any one of the sixteen indices is arbitrarily assigned to the codeword w₁. Then, the first tier indices are assigned to the first tier codewords, the second tier indices are assigned to the second tier codewords, and the third tier indices are assigned to the third tier codewords. For example, the index 0000 is assigned to the codeword w₁. Then, the indices 0001, 0010, 0100 and 1000 are assigned to the codewords w₂, w₄, w₈ and w₁₆, respectively. The indices 0011, 0110, 0101, 1100, 1010 and 1001 are assigned to the codewords w₃, w₅, w₆, w₇, w₉, w₁₃ and w₁₅, respectively. The indices 0111, 1101, 1111, 1110 and 1011 are assigned to the codewords w₆, w₁₀, w₁₁, w₁₂ and w₁₄, respectively.

In accordance with the third embodiment of the present invention, a codebook may be spontaneously generated by either of the wireless communication units 205 and 210 of the system 200 of FIG. 2. Construction and reconstruction of the codebook should link to each tier of codewords and should be based on associated Hamming distance with each tier. For example, for the two-tier indexing scheme, if the measured channel metric is in the first tier, a codebook (or the first codebook subset) having a size of 4 is constructed with a Hamming distance of one. Since the size of the codebook (or the first codebook subset) is reduced to 4 from 16, the first wireless communication unit 205 may use only two bits to represent one of the codewords in the first codebook subset as shown in the first column of Tables 1 and 2 previously as examples. If the measured channel metric is in the second tier, a codebook (the second codebook subset) having a size of 15, (preferably 15 if the second codebook subset is the combination of the first and second tiers, but it may be 11 if the second codebook subset is only the second tier), is constructed with a Hamming distance of 1, 2, 3 and 4, (or 2, 3 and 4). In this case, four (4) bits may be used to represent one of the codewords in the codebook.

Detection of the codebook may be correlation-based, number of feedback bits-based, or any other appropriate methods. In the correlation-based method, both of the wireless communication units 205 and 210 measure the correlation and, therefore, the second wireless communication unit 210 may detect the codebook. In the number of feedback bits-based method, the second wireless communication unit 210 detects the codebook based on the number of feedback bits.

The codebook construction is performed by XOR operation on the previous codeword with a codebook construction set. A codebook construction set of the first codebook subset (contains only the first tier) (i.e., Hamming distance of one) is:

B1=[0001, 0010, 0100, 1000].

(r1 or d1) (2-bit)
A codebook construction set (size of 11 case) of the second codebook subset (contains only the second tier) (i.e., Hamming distance of two or greater) is:

B2=[0011, 0101, 0110, 0111, 1001, 1010, 1011, 1100, 1101, 1110, 1111].

(r2-r1 or d2-d1) (4-bit)
Alternatively, a codebook construction set (size of 15 case) of the second codebook subset (contains both the first and second tiers) (i.e., Hamming distance of one or greater) is:

B3=[B1, B2]=[0001, 0010, 0100, 1000, 0011, 0101, 0110, 0111, 1001, 1010, 1011, 1100, 1101, 1110, 1111].

(r2 or d2) (4-bit)

For a previous codeword 0000, the first tier codebook is generated as follows:

[0001, 0010, 0100, 1000].

This is obtained by performing XOR-ing of the index 0000 with B1. For each codeword the corresponding codebook subsets can be generated using B1 and B2 or B3.

For three-tier indexing scheme of the second embodiment, if the measured channel metric is in the first tier, a codebook of size 4 is constructed with a Hamming distance of 1, if the measured channel metric is in the second tier, a codebook of size 6 is constructed with a Hamming distance of 2, and if the measured channel metric is in the third tier, a codebook of size 5 is constructed with a Hamming distance of 3 and 4. The codebook construction is performed by XOR operation on the previous codeword with the codebook construction set.

For example, a codebook construction set of the first codebook subset (that is the first tier) (i.e., Hamming distance of one) is:

C1=[0001, 0010, 0100, 1000](2-bit).

A codebook construction set of the second codebook subset which is the second tier (i.e., Hamming distance of two) is:

C2=[0011, 0101, 0110, 1001, 1010, 1100](3-bit).

Alternatively a codebook construction set of the second codebook set which contains both the first and second tiers (i.e., Hamming distance of one and two) is:

D2=[C1, C2]=[0001, 0010, 0100, 1000, 0011, 0101, 0110, 1001, 1010, 1100](4-bit).

A codebook construction set of the third codebook subset which is the third tier (Hamming distance of three and four) is:

C3=[0111, 1011, 1101, 1110, 1111](3-bit).

Alternatively, a codebook construction set of the third codebook subset which contains all the tiers including the first, second and third tiers (Hamming distance of one, two, three and four) is:

D3=[C1, C2, C3]=[0001, 0010, 0100, 1000, 0011, 0101, 0110, 1001, 1010, 1100, 0111, 1011, 1101, 1110, 1111](4-bit).

For example, for a previous codeword 0000, the second tier codebook is:

[0011, 0101, 0110, 1001, 1010, 1100].

This is obtained by performing XOR-ing of the index 0000 and C2. For each codeword the corresponding codebook subsets can be generated using C1, C2, or D2 and C3 or D3.

The reduced size of feedback signaling (codebook subset index) is then reconverted to indices of a global codebook. For example, for the codeword 0000, the first tier 4 bit global codebook (Hamming distance of one) is generated as follows:

[0001, 0010, 0100, 1000].

Each of 2 bit first tier local indices=00, 01, 10, 11 corresponds to a 4 bit global global codebook index=0001, 0010, 0100, 1000, respectively, (e.g., as shown previously in Table 1). For the two-tier indexing scheme, for a previous codeword 0000 and a Hamming distance of one, if the selected codeword for the next feedback is 0100, a feedback of a local index (2 bits) ‘10’ points to the third index of the first tier global codebook.

For the three-tier indexing scheme, for codeword=0000, the second tier codebook of Hamming distance of 2 is as follows:

[0011, 0101, 0110, 1001, 1010, 1100].

One of the second tier local index (3 bits)=000, 001, 010, 011, 100, 101 may be sent back to indicate a global codebook index (4 bits)=0011, 0101, 0110, 1001, 1010, 1100, respectively. For example, if the previous codeword is 0000 and the selected codeword for next feedback is 1001, the feedback of a local index (3 bits) ‘011’ points to the fourth index of the second tier global codebook.

Another embodiment is that a codebook subset can contain partial/mixed tiers. Furthermore, a codebook subset can contain the “original” codeword to accommodate the case when the codeword is not changed between updates from a previous to current codeword, or from a current to next codeword due to no change or almost no change of channel conditions. The “original” codeword is referred to as the previous codeword, which is used for the current codeword update, or the current codeword, which is used for the next codeword update. In general, a codebook subset is not equivalent to a codebook tier. A codebook tier is determined by the “distance” with respect to the reference codeword, while a codebook subset may contain partial/mixed codebook tiers or mix of codewords in different codebook tiers.

For one implementation, the first codebook subset can contain the original codeword, (the codeword which is used for the update or will be updated), and part of the codewords in the first tier. The second codebook subset can contain an original codeword, codewords in the first tier and part of codewords in the second tier. A codebook construction set of the first codebook subset, (including the original codeword, i.e., having a Hamming distance of zero and part of other codewords having a Hamming distance of one) is:

E1=[0000, 0001, 0010, 0100](2-bit).

A codebook construction set (size of 16 case) of the second codebook subset, (i.e., all Hamming distance of zero, one or greater), is:

E2=[0000, 0001, 0010, 0011, 0100, 0101, 0110, 0111, 1000, 1001, 1010, 1011, 1100, 1101, 1110, 1111](4-bit).

For a previous codeword w₁ (or 0000), the first codebook subset is generated as follows:

[0000, 0001, 0010, 0100].

### This is obtained by performing XOR-ing of the index 0000 with E1.

For a previous codeword w₅ (or 0110), the first codebook subset is generated as follows:

[0110, 0111, 0100, 0010].

### This is obtained by performing XOR-ing of the index 0110 with E1.

For each codeword, the corresponding codebook subsets can be generated using E1 and E2. For example, Tables 3 and 4 below shows the codebook subset index to global codebook index translation tables using codebook construction set E1 for codewords w1 and 5 respectively.

TABLE 3
Codebook subset index to global codebook index translation table
using E1 for codeword w₁

| Codebook Subset Index | Global Codebook Index |
|---|---|
| 00 | 0000 |
| 01 | 0001 |
| 10 | 0010 |
| 11 | 0100 |

TABLE 4
Codebook subset index to global codebook index translation table
using E1 for codeword w₅

| Codebook Subset Index | Global Codebook Index |
|---|---|
| 00 | 0110 |
| 01 | 0111 |
| 10 | 0100 |
| 11 | 0010 |

For a three tier codebook, one implementation can have the first codebook subset contain the original codeword (the codeword which will be updated) and part of the codewords in the first tier. The second codebook subset contains part of codewords in the first tier and part of codewords in the second tier. The third codebook subset contains part of codewords in the second tier and codewords in the third tier. A codebook construction set of the first codebook subset (i.e., Hamming distance of zero and one) is:

F1=[0000, 0001, 0010, 0100](2-bit).

### F1 is the same as E1 in this case.

A codebook construction set of the second codebook subset (i.e., Hamming distance of one and two) is:

F2=[1000, 0011, 0101, 0110](2-bit).

A codebook construction set of the third codebook subset (Hamming distance of two, three and four) is:

F3=[1001, 1010, 1100, 0111, 1011, 1101, 1110, 1111](3-bit).

For example, for a previous codeword w1 (or 0000), the second codebook subset is:

[1000, 0011, 0101, 0110].

This is obtained by performing XOR-ing of the index 0000 and F2. For each codeword the corresponding codebook subsets can be generated using F1, F2 and F3. For example, Tables 5 and 6 show the codebook subset index to global codebook index translation tables for codeword w1 using F2 and F3 respectively.

TABLE 5
Codebook subset index to global codebook index translation table for F2
and codeword w₁

| Codebook Subset Index | Global Codebook Index |
|---|---|
| 00 | 1000 |
| 01 | 0011 |
| 10 | 0101 |
| 11 | 0110 |

TABLE 6
Codebook subset index to global codebook index translation table for F3
and codeword w₁

| Codebook Subset Index | Global Codebook Index |
|---|---|
| 000 | 1001 |
| 001 | 1010 |
| 010 | 1100 |
| 011 | 0111 |
| 100 | 1011 |
| 101 | 1101 |
| 110 | 1110 |
| 111 | 1111 |

Another implementation can have the first codebook subset contain the original codeword (the codeword which will be updated) and part of the codewords in the first tier. The second codebook subset contains the first codebook subset and additional codewords in the first tier, and part of codewords in the second tier. The third codebook subset contains the second codebook subset and additional codewords in the second tier, and codewords in the third tier. In this case, the third codebook subset is equal to the global codebook such as the one shown in FIG. 4. A codebook construction set of the first codebook subset (i.e., Hamming distance of zero and one) is:

G1=[0000, 0001, 0010, 0100](2-bit).

A codebook construction set of the second codebook subset (i.e., Hamming distance of zero, one and two) is:

G2=[G1, 1000 0011, 0101, 0110]=[0000, 0001, 0010, 0100, 1000 0011, 0101, 0110](3-bit).

A codebook construction set of the third codebook subset (Hamming distance of two, three and four) is:

G3=[G2, 1001, 1010, 1100, 0111, 1011, 1101, 1110, 1111]=[0000, 0001, 0010, 0100, 1000 0011, 0101, 0110, 1001, 1010, 1100, 0111, 1011, 1101, 1110, 1111](4-bit).

For example, for a previous codeword 0000, the second codebook subset is:

[0000, 0001, 0010, 0100, 1000 0011, 0101, 0110].

### This is obtained by performing XOR-ing of the index 0000 and G2. For each codeword the corresponding codebook subsets can be generated using G1, G2 and G3.

FIG. 7 shows a codebook indexing reporting method in accordance with the present invention. It is assumed that the table shown in FIG. 7 is organized such that the codewords that are close to each other in the Hamming sense are listed consecutively. The number of bits in feedback signaling and frequency of the feedback signaling may be traded off. For example, assume that two levels of indexing are reported. If the frequency of the reporting a first level index is less frequent, more bits may be used for the reporting. If the frequency of the reporting a second level index is more frequent, then fewer bits may be used for the reporting. Thus, the first level index is reported less frequently than the second level index.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WIAN) module.

What is claimed is:

1. A method of indexing codebook and codeword feedback, the method comprising:
(a) performing at least one measurement of a channel metric;
(b) selecting a subset of a predetermined global codebook based on the measurement of the channel metric, the selected codebook subset including a plurality of codewords and a plurality of respective indices;
(c) selecting a particular one of the codewords in the selected codebook subset based on a certain criterion;
(d) assigning a codebook subset index to the selected codeword; and
(e) transmitting a feedback signal including the assigned codebook subset index.

2. The method of claim 1 further comprising partitioning a plurality of codewords into multiple tiers, wherein the codewords are arranged in such a way that for any given codeword, first tier codewords have the highest correlation, and remote tier codewords have the lowest correlation with respect to the given codeword.

3. The method of claim 1 further comprising partitioning a plurality of codewords into multiple tiers, wherein the codewords are arranged in such a way that for any given codeword, first tier codewords have the largest inner product, and remote tier codewords have the smallest inner product with respect to the given codeword.

4. The method of claim 2 wherein a plurality of indices are arranged in such a way that, for any given index, indices assigned to the first tier codewords have the smallest Hamming distance, and the indices assigned to the remote tier codewords have the largest Hamming distance with respect to a given codeword.

5. The method of claim 1 further comprising spontaneously generating the predetermined global codebook and codebook subset by associated Hamming distance with each tier and each codebook subset based on which tier and codebook subset the measured channel metric is in.

6. The method of claim 1 further comprising performing codebook construction by applying an XOR operation on a previous or current codeword with a codebook construction set.

7. The method of claim 1 wherein a codebook subset can contain an “original” codeword when the codeword is not changed between updates from a previous to a current codeword, or from a current to a next codeword due to no change or almost no change of channel conditions.

8. The method of claim 1 wherein a codebook subset contains partial/mixed codebook tiers or a mix of codewords in different codebook tiers.

9. The method of claim 1 further comprising:
(f) receiving the feedback signal;
(g) selecting a codebook subset based on the measurement of the channel metric;
(h) translating the assigned codebook subset index included in the feedback signal to a global codebook index; and
(i) mapping the global codebook index to a codeword.

10. The method of claim 1 wherein the channel metric is vehicle speed.

11. The method of claim 1 wherein the channel metric is channel correlation.

12. The method of claim 1 wherein the channel metric is channel variation rate.

13. The method of claim 1 wherein the channel metric is Doppler shift.

14. The method of claim 1 wherein the channel metric is a phase change.

15. The method of claim 1 further comprising:
partitioning a plurality of codewords into two or more tiers;
assigning indices to the codewords; and
correlating the codewords in complex vector space and Hamming distance in binary indices.

16. The method of claim 15 wherein the plurality of codewords includes sixteen codewords.

17. The method of claim 1 wherein the certain criterion is signal-to-interference-plus-noise ratio (SINR).

18. The method of claim 17 further comprising:
searching through codewords in the selected codebook subset to find the codeword that has the highest SINR.

19. The method of claim 1 wherein the certain criterion is mean square error (MSE).

20. The method of claim 19 further comprising:
searching through codewords in the selected codebook subset to find the codeword that has the lowest MSE.

21. The method of claim 1 wherein the certain criterion is channel capacity.

22. The method of claim 21 further comprising:
searching through codewords in the selected codebook subset to find the codeword that has the largest channel capacity.

23. A method of indexing codebook and codeword feedback, the method comprising:
(a) performing at least one measurement of a channel metric;
(b) receiving a feedback signal including an assigned codebook subset index;
(c) selecting a codebook subset based on the measurement of the channel metric;
(d) translating the codebook subset index included in the feedback signal to a global codebook index; and
(e) mapping the global codebook index to a codeword.

24. The method of claim 23 further comprising:
(f) selecting a subset of a predetermined global codebook based on the measurement of the channel metric, the selected codebook subset including a plurality of codewords and a plurality of respective indices;
(g) selecting a particular one of the codewords in the selected codebook subset based on a certain criterion;
(h) assigning a codebook subset index to the selected codeword; and
(i) transmitting the feedback signal including the assigned codebook subset index.

25. The method of claim 24 further comprising partitioning a plurality of codewords into multiple tiers, wherein the codewords are arranged in such a way that for any given codeword, first tier codewords have the highest correlation, second tier codewords have a medium correlation, and remote tier codewords have the lowest correlation with respect to the given codeword.

26. The method of claim 24 further comprising partitioning a plurality of codewords into multiple tiers, wherein the codewords are arranged in such a way that for any given codeword, first tier codewords have the largest inner product, second tier codewords have a medium inner product, and remote tier codewords have the smallest inner product with respect to the given codeword.

27. The method of claim 25 wherein a plurality of indices are arranged in such a way that, for any given index, indices assigned to the first tier codewords have the smallest Hamming distance, indices assigned to the second tier codewords have a medium Hamming distance, and the indices assigned to the remote tier codewords have the largest Hamming distance with respect to a given codeword.

28. The method of claim 24 further comprising spontaneously generating the predetermined global codebook and codebook subset by associated Hamming distance with each tier and codebook subset based on which tier and codebook subset the measured channel metric is in.

29. The method of claim 24 further comprising performing codebook construction by applying an XOR operation on a previous codeword with a codebook construction set.

30. The method of claim 24 wherein a codebook subset can contain an “original” codeword when the codeword is not changed between updates from a previous codeword to a current codeword, or from a current to a next codeword due to no change or almost no change of channel conditions.

31. The method of claim 24 wherein a codebook subset contains partial/mixed codebook tiers or a mix of codewords in different codebook tiers.

32. The method of claim 24 wherein the channel metric is vehicle speed.

33. The method of claim 24 wherein the channel metric is channel correlation.

34. The method of claim 24 wherein the channel metric is channel variation rate.

35. The method of claim 24 wherein the channel metric is Doppler shift.

36. The method of claim 24 wherein the channel metric is a phase change.

37. The method of claim 24 further comprising:
partitioning a plurality of codewords into two or more tiers;
assigning indices to the codewords; and
correlating the codewords in complex vector space and Hamming distance in binary indices.

38. The method of claim 37 wherein the plurality of codewords includes sixteen codewords.

39. The method of claim 24 wherein the certain criterion is signal-to-interference-plus-noise ratio (SINR).

40. The method of claim 39 further comprising:
searching through codewords in the selected codebook subset to find the codeword that has the highest SINR.

41. The method of claim 24 wherein the certain criterion is mean square error (MSE).

42. The method of claim 41 further comprising:
searching through codewords in the selected codebook subset to find the codeword that has the lowest MSE.

43. The method of claim 24 wherein the certain criterion is channel capacity.

44. The method of claim 43 further comprising:
searching through codewords in the selected codebook subset to find the codeword that has the largest channel capacity.

45. A wireless communication unit for indexing codebook and codeword feedback, the wireless communication unit comprising:
(a) a multiple-input multiple-output (MIMO) antenna;
(b) a receiver electrically coupled to the MIMO antenna, the receiver being configured to perform at least one measurement of a channel metric;
(c) a codebook index processor electrically coupled to the receiver, the codebook index processor being configured to (i) select a subset of a predetermined global codebook based on the measurement of the channel metric, the selected codebook subset including a plurality of codewords and a plurality of respective indices, (ii) select a particular one of the codewords in the selected codebook subset based on a certain criterion, and (iii) assign a codebook subset index to the selected codeword; and
(d) a feedback transmitter electrically coupled to the MIMO antenna and the codebook index processor, the feedback transmitter being configured to transmit a feedback signal including the assigned codebook subset index.

46. The wireless communication unit of claim 45 wherein the channel metric is vehicle speed.

47. The wireless communication unit of claim 45 wherein the channel metric is channel correlation.

48. The wireless communication unit of claim 45 wherein the channel metric is channel variation rate.

49. The wireless communication unit of claim 45 wherein the channel metric is Doppler shift.

50. The wireless communication unit of claim 45 wherein the channel metric is a phase change.

51. The wireless communication unit of claim 45 wherein the certain criterion is signal-to-interference-plus-noise ratio (SINR) and the codebook index processor searches through codewords in the selected codebook subset to find the codeword that has the highest SINR.

52. The wireless communication unit of claim 45 wherein the certain criterion is mean square error (MSE) and the codebook index processor searches through codewords in the selected codebook subset to find the codeword that has the lowest MSE.

53. The wireless communication unit of claim 45 wherein the certain criterion is channel capacity and the codebook index processor searches through codewords in the selected codebook subset to find the codeword that has the largest channel capacity.

54. A wireless communication unit for indexing codebook and codeword feedback, the wireless communication unit comprising:
(a) a multiple-input multiple-output (MIMO) antenna;
(b) a feedback receiver electrically coupled to the MIMO antenna, the feedback antenna being configured to receive a feedback signal including an assigned codebook subset index; and
(c) a codeword processor electrically coupled to the feedback receiver, the codeword processor being configured to (i) select a codebook subset based on the measurement of a channel metric, (ii) translate the assigned codebook subset index included in the feedback signal to a global codebook index, and (iii) map the global codebook index to a codeword.
